(19) United States
(12) Patent Application Publication
(10) Pub. No.: US 2018/0015373 A1
(43) Pub. Date: Jan. 18, 2018

(54) Addiction/Compulsive Behavior Recovery and Relapse Prevention Gaming Simulation Platform

(71) Applicant: Daniel Greenberg, Washington, DC (US)

(72) Inventor: Daniel Greenberg, Washington, DC (US)

(21) Appl. No.: 15/648,435

(22) Filed: Jul. 12, 2017

Related U.S. Application Data
(60) Provisional application No. 62/361,003, filed on Jul. 12, 2016.

(51) Int. Cl. A63F 13/822; G09B 5/06; A63F 13/85; A63F 13/215; A63F 13/213; G09B 19/00; A63F 13/211

(52) U.S. Cl. CPC A63F 13/822; G09B 19/00; G09B 5/065; A63F 13/211; A63F 13/215; A63F 13/213; A63F 13/85

(57) ABSTRACT

A new method and gaming system for recovery and relapse prevention for individuals recovering from addictive and compulsive behavior including drugs and/or alcohol is described. The system employs a series of video games configured to reinforce recovery actions, including rehearsing and reinforcing refusal language, which facilitates and expedites the recovery of an individual that has experienced problems with drugs and/or alcohol. The games provide a means of practice and training negative responses to drugs in the game world to assist with drug refusal in real-world settings, and requires the player to employ physical movements as well as verbal commands similar to those used to say ‘no’ to drugs in reality. The system preferably requires the use of a motion detection system and microphone, such as a Microsoft Kinect™ accessory. The system provides an educational and entertaining outlet for players wishing to better their lives by refusing drugs and/or alcohol.

### CONTINUITY

This application is a non-provisional application of provisional patent application No. 62/361,003, filed on Jul. 12, 2016, and priority is claimed thereto.

### FIELD OF THE PRESENT INVENTION

The present invention, relates generally to systems and methods configured to facilitate and expedite recovery from addictive and compulsive behavior (like drug and/or alcohol addiction) and prevent relapse via therapeutic treatment, and more specifically relates to a three-dimensional video gaming environment and system in which players may hone and rehearse anti-addiction practices, like anti-drug behaviors during inpatient and outpatient treatment and recovery.

### BACKGROUND OF THE PRESENT INVENTION

It is known that recovery from addiction, whether substance dependence (drugs or alcohol) or non-pharmacologic impulse control disorders (problem gambling), can be difficult for most individuals. This struggle is seen world-wide, as the chronic, long-term illness of addiction continues to have adverse effects on the lives of countless individuals and their loved ones. Many treatment and rehabilitation facilities are available to help these individuals conquer their addictions, however a rate of attrition still remains high at many facilities, with high rates of relapse during outpatient treatment, requiring a return to inpatient treatment and risking more adverse consequences like overdose, and even death. It is envisioned that video game play can be conducive to motivating individuals in recovery to continue their outpatient treatment, can provide a fun, entertaining, and group-bonding outlet during scheduled outpatient visits to the treatment center, and can function as a behavioral intervention, including providing therapeutic doses of drug-resisting training and rehearsing refusal language.

Some facilities have employed anti-addiction board games and card games as a means to engage young people in combatting the influence of drugs and have expressed interest in drug treatment video games which can engage young people far more effectively than board games or card games. Some of the games of the prior art incorporate physical motions as a form of game control, and even use images of drugs and alcohol as in-game enemies or objects to be avoided such as the game Take Control™. However, presently no drug/alcohol/addiction treatment game exists that employs industry standard, state-of-the-art, real-time three-dimensional rendered video game elements instead of dated, two-dimensional video cutouts on two-dimensional, static backgrounds. The other physical motion-controlled game with drug enemies (Take Control) uses flat two-dimensional video avatars, two-dimensional enemy objects, and flat two-dimensional backgrounds. Digitized, two-dimensional video avatars were once considered state-of-the-art in video games (the 1992 Mortal Kombat™), but they fell out of favor and have not been considered industry standard for two decades because they look flat and unexciting, especially compared to the versatility of real-time, interactive 3D animated avatars. Two-dimensional, digitized, full-motion video (FMV) avatars cannot move convincingly through three-dimensional space, but instead they glide from side to side like a paper doll on a flat background. The video game market has rejected this FMV approach, which is now exceedingly rare in video games, because it distances players from the gameplay experience. FMV gameplay is mostly seen in low quality “serious games” which game players have been known to reject for their lack of professional game industry elements. Failing to meet minimum player expectations reduces the potential effectiveness of video games as treatment therapies.

Similarly, two-dimensional FMV digitized images of enemy objects look like flat cutouts on a flat background, only able to slide along two axes of motion without realistic rotation. They not only lack the depth inherent in three-dimensional rendered objects, but they cannot move through the depth of the background, since the background is a flat two-dimensional surface which only has the illusion of depth. That illusion dispels as the avatar and enemy objects only move along a flat plane, revealing that they have no depth in the scene. Non-FMV animated games work well in two dimensions as well as three dimensions, as the animated images are not trying to look like realistic video images of people. But FMV avatars and enemy objects appear to be photorealistic, so players expect them to move not only right/left up/down, but forward/back. When these realistic FMV images cannot move forward or back, they look unrealistically pasted on the background, and can cause players to experience an unpleasant “uncanny valley” effect. (Wikipedia: “the uncanny valley is the hypothesis that human replicas which appear almost, but not exactly, like real human beings elicit feelings of eeriness and revulsion (or uncanniness) among some observers.”) FMV avatars look realistic but cannot appear to move through space in three-dimensional perspective—a system which is a hallmark of modern video gaming. It prevents all the kinds of gameplay which require movement in three-dimensional space, like three-dimensional racing games. This limited gameplay undercuts the sense of immersion required for people in recovery to become deeply engaged in the video game—essential if the video game is to have an effect on treatment outcomes.

Further, video avatars available in the current recovery/treatment game appears grainy, blurry, and slow-moving. Their layering on the static two-dimensional background photograph shows a pixelated “halo” effect, similar to a badly composited weather map. The grainy-edged, artificial look of the avatar has a distinctly amateur, dated effect, which distances players from the game. Games with video were briefly popular in the 1990s, but fell out of favor due to the many limitations of the form as three-dimensional game developers became more proficient at rendering three-dimensional avatars and enemies in real-time three-dimensional environments. (Wikipedia: “ . . . the popularity of games loaded with live-action and FMV [full-motion video] faded out in the late 1990s . . . ” https://en.wikipedia.org/wiki/Full_motion_video). Playing in a flat, video world fails the expectations of contemporary video game players, who have been conditioned by over two decades of three-dimensional art to expect gameplay which is (literally) deeper. This dated look also distances the audience from the gameplay. A video game with such slow, dated and limited gameplay is less likely to engage its audience, thus limiting its effectiveness.

Video avatars have another major limitation not shared by three-dimensional avatars. Because the motion-sensing camera views the front of the player as the player faces the game screen, the avatar can only depict the front of the players. This is acceptable for a small subset of game types, but a far wider variety of game types require the game to depict the back of the player, like driving games, running games, shooting games, climbing games, and all first-person games.

Thus, there is a need for a recovery treatment gaming system configured to provide the player with a three-dimensional, realistic environment in which an avatar of the player may be controlled to simulate real-world drug avoidance and refusal, while promoting positive life aspects. Such games would preferably include a variety of 3D animated avatars that reflect the diversity of the players, while also reflecting an aspirational “best self.” By controlling an avatar that looks like the player, the player can more directly relate to the subject material. By controlling an avatar who also looks like the best version of themselves, the players can also relate to the future self they are becoming by staying clean of their dependency. This is not possible with games that only show a cutout of the player's video image, as such an image can never show an aspirational “best self” Preferably these recovery/treatment games would provide multiple levels of difficulty, and would be dynamic such that players can select which drugs they wish to avoid/fight against, and which ‘good things’ they wish to strive for instead.

Other games designed to help addicted populations, such as Take Control™ incorporate voice recognition for superficial interface elements outside of gameplay, like using voice to begin gameplay or to select a static background for the gameplay. The games of the present invention use voice recognition as a direct, integrated competent of both gameplay and recovery. In the games of the present invention, players gain practice in speaking drug refusal phrases by saying them during gameplay to gain in-game bonuses. For example, if the player is losing health from collision with drugs, speaking a phrase like “I'm clean” can restore some health and avoid the game ending due to loss of health. If the player's climbing path is blocked by drugs which diminish the Health Meter when grabbed, the player can say “I'm clean” to wipe out the dangerous drugs blocking his path, transforming them into safe climbing handholds. Practice or role-playing speaking refusal phrases can be an effective part of substance abuse recovery. Voice recognition for refusal language rehearsal is a novel innovation of the present invention.

Additionally, existing recovery games such as Take Control™ also only allow a single form of drug gameplay, in which the player's avatar must hit a drug to break it, similar to the popular mobile phone application ‘Fruit Ninja’™. This is unlike the present invention, which provides multiple modes of drug gameplay, with more game modes able to be added through expansions and downloadable content.

Because players like to challenge themselves and each other to do better than before, the present invention records player high scores. This professional game feature does not appear in existing recovery games, but is important here because it can motivate people to return to treatment to better their old scores, and beat their friend's scores. These scores can be viewed in the game on a High Score page, and also output as data in a file, along with other elements such as the duration of time played. Having the game deliver data on time played and high scores achieved can be useful to treatment providers.

The present invention preferably uses the Microsoft™ Kinect™ to control the game by turning the player's drug avoiding/rejecting motions and drug refusal voice commands into real-time game controls. This provides an extra advantage to players, because addiction often causes physical weakness and because exercise has been shown to be helpful for recovery. The Microsoft Kinect is useful but not essential to the invention, which could also use other motion controllers like the Nintendo™ Wii™ remote, the Sony™ Move™ controller, virtual reality controllers like the Oculus™ Touch™ or even a new line of gesture control devices from companies like Leap Motion™. The motion and voice control of the Microsoft Kinect could be replaced by other forms of input, like a PC with mouse, keyboard, and microphone, a video game console with a game controller, a tablet/smartphone with tough controls like swiping, or other forms of control. For systems without microphones for voice recognition, players could click dialogue balloons to have their character speak refusal language phrases, which in turn conveys gameplay benefits. This might not be as immediate or impactful as the player directly speaking the phrases, but the player can still hear them spoken by their avatar after the player selects the refusal phrase.

All of these elements add up to a game built with many more state-of-the-art, game industry features. This makes it more likely that patients will find it appealing enough to play frequently, in order to show a beneficial effect in assisting with recovery and preventing relapse.

### SUMMARY OF THE PRESENT INVENTION

The present invention relates to a new system of drug and alcohol recovery/treatment video games configured to immerse the player in a three-dimensional environment. The games include the use of a three-dimensional avatar, which is can be selected from a range of avatars representing different races, genders, dress styles, etc. The present invention is intended to be a therapeutic tool that synergistically augments other current treatment modalities for drug and/or alcohol recovery. It is envisioned that the game's efficacy, adoption, dissemination and sustainable commercial success is to be as a therapeutic tool embedded within existing treatment programs, especially those aimed at adolescents and young adults, though they can be aimed at all ages in recovery and can also be used outside of a treatment program. The present invention is configured to increase treatment engagement by making treatment more fun and participatory. Additionally, the gameplay treatment combined with conventional treatment will synergistically reinforce each other in terms of the messages and skills learned in each setting. Therefore, it is important to develop a counselor protocol for implementing the game play in order to optimize the synergy in both inpatient and outpatient treatment.

The present invention uses motion and voice controls, which allow players to control the gameplay with their bodily motions and their voice, which help to completely engage and immerse the players into the game. Players can jump, punch, chop, wave their arms, dodge, steer, and make a wide variety of climbing motions, and their three-dimensional avatar onscreen does the same gesture. The games of the present invention preferably employ the Microsoft Kinect™ for inexpensive audio, video, and infrared depth sensors to convert player motion and spoken words into game controls. This innovation uses state-of-the-art real-time three-dimensional animated avatars moving in three-dimensional space designed with video-game industry best practices to engage players long enough for them to gain a therapeutic dose of gameplay.

### BRIEF DESCRIPTION OF THE DRAWINGS

The present invention will be better understood with reference to the appended drawing sheets, wherein: FIG. 1 displays a screenshot of the Recovery Racer portion of the game of the present invention.

FIG. 2 exhibits a screenshot of the Recovery Climber portion of the game of the present invention

FIG. 3 shows a screenshot of the Recovery Runner portion of the game of the present invention

FIG. 4 depicts a screenshot of the Recovery Ninja portion of the game of the present invention

### DETAILED DESCRIPTION OF THE PREFERRED EMBODIMENT

The present invention is a multi-game drug and alcohol recovery mechanic configured to reinforce the negativity of drugs and alcohol on a player's life, while simultaneously enabling the player to strive for ‘good things’ in life and simultaneously rehearsing drug refusal language for in-game success. The preferred embodiment of the present invention includes four games (though they may be sold separately): Recovery Racer (10), Recovery Climber (20), Recovery Runner (30), and Recovery Ninja (40).

Each of the games of the present invention includes the use of a player avatar (50), which is preferably constructed to mimic the appearance of the player who is in recovery/treatment or a stronger, more confident, aspirational version of themselves (in the future when they have been successful in recovery). Onscreen drugs (60) appear as obstacles, which players must avoid, destroy, or transform, using a combination of body gestures and/or spoken refusal phrases to in order to succeed, counteract losses, collect beneficial items, and earn points. This computer hardware enables player rehearsal of drug evasion, destruction, and transformation which is not practical in real-life therapeutic drug treatment role-playing sessions without a computer and the game software. Players preferably employ a Microsoft™ Kinect™ accessory (which incorporates a camera, infra-red sensor, and microphone), and must employ bodily movements and voice commands to play each game. The game could also use other forms of bodily motion detection, including accelerometers like those in smartphones, the Nintendo Wii, or Sony Move, or virtual reality controllers like the Oculus Touch or Vive controller. These kinds of hardware enable actions that can't be reproduced in real life without the hardware, a computer and the custom game software. Recovery Racer (10) has players racing on a motorcycle or other vehicle, and must destroy the drugs (60) shown on the screen in order to progress in Destroy Mode, or avoid the drugs (60) shown on the screen while collecting beneficial items (diplomas, engagement rings, etc.), shown as ‘good items’ (80) in order to progress in Discernment mode. These beneficial items can be selected by each player so they only see the items that are most meaningful to their lives and their recovery. For example, a player who sees a relationship and marriage as an important life goal to help with sobriety can choose to select engagement rings and wedding rings to be among their “goodies.” By contrast, a player who prefers to be single or get out of a co-dependent relationship with a drug dealer may not think of rings as a positive item, and could choose to not include them. Successfully speaking refusal phrases produces beneficial gameplay effects, like expanding the player's ability to destroy the drugs or collect the good items. This hardware and software voice recognition system allows players to rehearse refusing drug offers, which is an essential skill in drug recovery and relapse prevention.

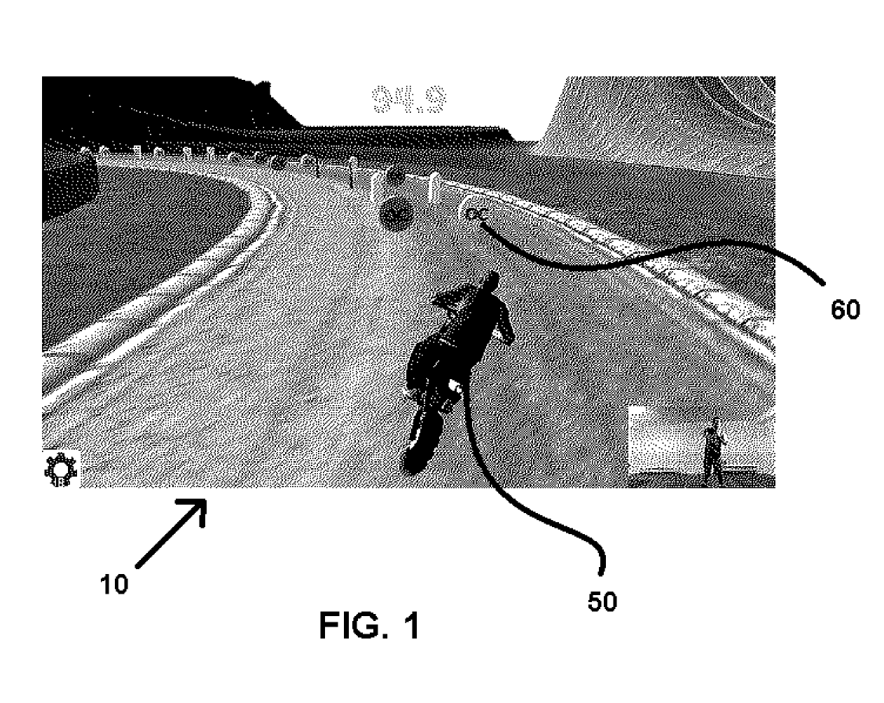

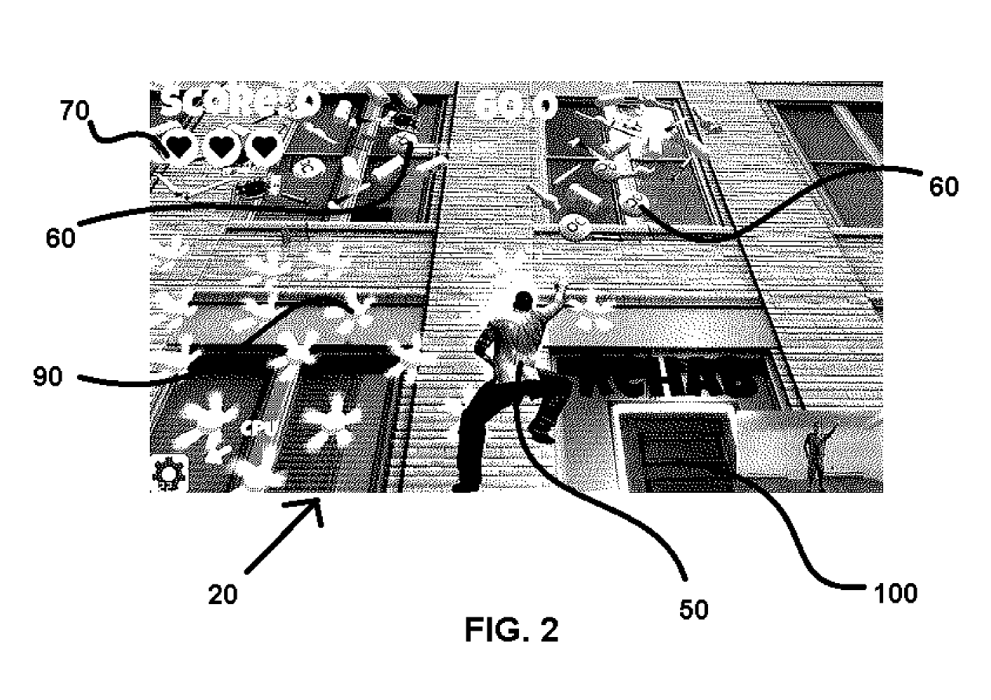

Recovery Climber (20), shown in FIG. 2, has players climbing a wall, such as that of a building. The players must avoid the drugs (60), which are present on the wall and which reduce the player's health when grabbed. Grabbing the safe handholds (90) does not reduce health.

Successfully speaking drug refusal phrases transforms some of the onscreen drugs (60) blocking the player's into safe handholds (90), reinforcing the power of refusal language to get drugs out of the way of people in recovery. This is only possible with voice recognition hardware and custom software. Reaching the Rehab Door (100) powers up the player to successfully use Refusal Language, reinforcing the positive role of continuing to return to outpatient treatment. Voice recognition hardware and software integrated with the physical motion control is essential for motivating the repeated rehearsal of drug refusal skills.

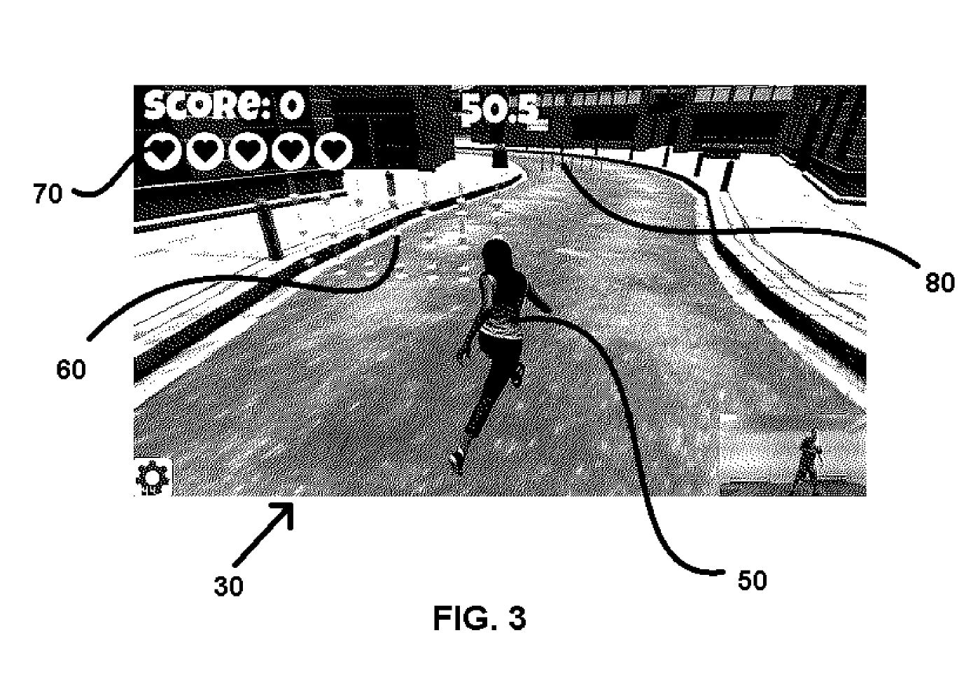

Recovery Runner (30) has players running an obstacle course on foot, as shown in FIG. 3. Each obstacle is a drug or drug-related item, which players must avoid in order to succeed. Touching drugs along the path reduces the avatar's Health Meter (70). The player must quickly draw their hand back, sidestep, leap away or otherwise immediately recoil from the appearance of the drug to not lose the game. This trains a rapid compulsion to avoid the drug. This is essential for overcoming the addict's compulsion to move toward the drug. When the players physically train themselves to have a competing impulse away from drugs, they can slow, interrupt, or cancel the addictive impulse toward the drug. This physical training is enabled only by body motion-controlled hardware working in conjunction with avatars in the game world. Complete loss of health shown in the health meter (70) ends the game, reinforcing the dangers of the drugs. This happens when the player has not successfully used their body and voice to destroy/evade or speak refusal language. This loss is important to reinforce the future negative consequences of the drugs, which is often ignored or overlooked by addicts when they relapse. Failure in the game helps bring the negative feelings of drug addiction to the present during an episode of craving, giving players a better chance of refusing. This reinforcing feeling is strong because it is a bodily sensation (muscle memory), which is only possible with motion tracking hardware combined with voice recognition hardware. Successfully speaking refusal phrases increases the Health Meter (70), reinforcing the power of drug refusal skills in helping with recovery, even after a slip, an increase in cravings, or a visit to an area with drugs. In Discernment Mode, the player must avoid the drug obstacles (onscreen drugs (60)) while collecting as many good items (80) as possible (diplomas, engagement rings, etc. This is only possible with body motion detection hardware paired with voice recognition hardware.

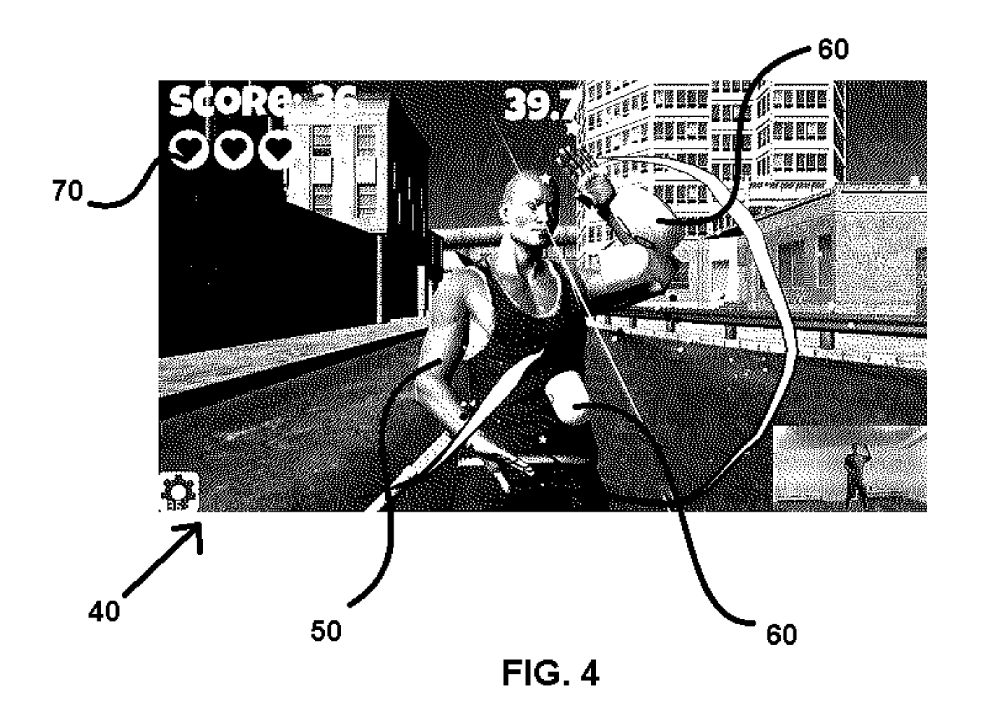

As shown in FIG. 4, Recovery Ninja (40) in Destroy Mode has players destroying drugs (60) by swiping their hands, similar to swatting in real life. Failing to destroy drugs that come near the avatar results in a reduction in the health meter (70). Complete loss of health ends the game. In Discernment Mode, the player must avoid touching the drugs (60) while making swiping motions with their arms to collect as many good items (80) as possible (diplomas, engagement rings, etc.). For players who are angry at their addiction, this can be more effective than evading drugs. This action is impractical to be replicated in real-life training without the computer hardware, as throwing drugs and drug paraphernalia at players in real-life is not feasible.

The games of the present invention employ drug destruction as a gameplay form, similar to the prior art, but two additional modes are provided to players in recovery/treatment: drug avoidance and drug discernment. In drug avoidance mode, the player must evade onscreen drugs (60) rather than try to strike them. In the drug discernment mode, the player must evade the drugs (60) but must also collect good items representative of sobriety, maturity, and health (car keys, wedding rings, footballs, etc.). Drug discernment is far more demanding gameplay, as the player cannot simply move away from every object or leap toward every object. Players must concentrate and remain keenly aware to avoid dangers and collect “goodies.” This physical recoil paired with a physical outreach is only possible with motion detection hardware. Test subjects have consistently chosen this game mode as the most popular/rewarding of all game modes of the present invention, as it feels the most like the challenges they face in real life of trying to pursue useful rewards, while always having to remain vigilant against drug cravings or drug offerors.

Addictions and compulsive behaviors are dangerous because the person develops an unthinking response to satisfy a momentary craving, even though cravings often pass quickly if the person does not act on them. Impulse control disorders cause a person to feel a compulsion to react positively to cravings. But people in recovery are not helpless to change their patterns and respond differently to the appearance of drugs or the opportunity to attain drugs.

Behavioral therapy can help bring about physical changes in the part of the brain that governs impulses. The Discernment game mode is intended to train players to immediately react negatively to the appearance of drugs, replacing a dysfunctional positive reaction in favor of the drug with a negative reaction. While time the player is intently focused on collecting good things in the game, the player must suddenly respond negatively to the sudden appearance of a drug—or be harmed by it. This training in instantaneous negative responses to drugs can possibly disrupt the positive response and give the person more time and thought to resist the craving. With enough training it may also possibly negate the positive response and replace it altogether. Just as auto safety simulators can train drivers to react instantly with a safe motion to the sudden appearance of danger, a goal of Recovery Warrior is to train people in recovery to react instantly with a rejecting response to the sudden appearance or offer of drugs. This is why physical motion detections is essential. The refusal phrases are likewise trained until they become automatic, which corresponded with making them easier to say in real life during drug offering circumstances.

These multiple modes of the present invention are novel in therapeutic software for improving treatment outcomes and preventing relapse.

### Control Over the Good Items

Players can select the good items they want to collect in the game from a long list. This allows them to customize the gameplay experience according to their individual aspirations. Patients have reported that they find this very rewarding, as seeing the good things they want in life (an education, a job, a relationship) allows them to stay focused on the good things they want in life rather than backsliding into negative influences like drugs. Seeing these elements within the game, and turning to these good choices rather than drugs or alcohol is psychologically healthy.

### Control Over the Drugs of Choice

The competing products presently on the market only allow only one drug to appear at a time, and selected only from a very small range of substance categories: Alcohol, Cigarettes, and a catch-all category called “Pills.” The “Pills” category only shows pill bottles and does not distinguish between the kinds of drugs in them. Missing are drugs like injection heroin, marijuana, hallucinogens, etc. Conversely, the games of the present invention allow treatment centers to select multiple drugs to appear in each game instead of just one, which is important, as addiction is often multi-dimensional (patients often using more than one type of substance). The games of the present invention include alcohol and tobacco products, and allows for the customization of multiple types of drugs of choice, including, but not limited to opioids, injection heroin, marijuana, stimulants, etc. All of the types of drugs chosen by the player will show up in each of the games that patient plays, not just one type of drug, as in the prior art. The 3D images of the drugs are far more specific, including depictions of individual pills (not just pill bottles) and drug paraphernalia.

### Multiple Difficulty Settings for the Varied Strength Levels of Recovering Addicts

Games disclosed in the prior art, such as Take Control™, provide a single difficulty mode. So, another novel aspect to the therapeutic product of the present invention over other drug treatment competitors is the use of five levels of difficulty to accommodate different skills of players and multiple modes of gameplay. Multiple levels of difficulty are essential to continued use of the present invention, as some people in treatment are detoxing from heroin addiction and are very weak. They cannot sustain high levels of exertion. The present invention incorporates a “Casual” mode and an “Easy” mode for such players, along with people new to motion-based gaming. As players master these modes and gain strength, they can move up to ‘Normal’ difficulty mode, where most players will play the majority of the games of the present invention. As players get better at the game, they can step up to new challenge levels with ‘Hard’ and even ‘Extreme’ difficulty modes for the most demanding gameplay setting. Patients with greater video game skills require faster gameplay for greater challenge. Fast-paced gameplay is available at the higher challenge levels of the ‘Recovery Warrior’ games of the present invention, but is not found in other games for addiction of the prior art.

Counselor Handbook for Integration into Treatment

It should be understood that the present invention is to be bundled with a comprehensive manual for use as a therapeutic recovery tool. Elements of treatment integration and counselor facilitation preferably include: comfort, competence and “ownership” of the game by counselors as a therapeutic tool; logistics of incorporation of the game into the agenda and flow of treatment (dose, timing, schedule etc.); the counselor role as enthusiast and cheerleader for the game; the counselor role as manager of game play (managing the equipment, facilitating turn taking and fair play, managing the right balance of rowdiness and order, ensuring safety etc.); the counselor role as debriefing and processing the content of the game as it relates to recovery and treatment messages.
The following are a partial list of examples of the topics that are covered in the manual accompanying the games of the present invention:
The importance of mastery of refusal skills in addiction recovery
How counselors can energize patients through physical activation, increasing their levels of arousal, making them more enthusiastic in their motivation and “fired up” towards the goals of treatment
How counselors can manage and direct the energy of the individual and/or group to keep the focus on recovery content and goals, and to prevent over-exuberance from becoming chaotic or disruptive
Utilizing counselor facilitation to debrief and process the thoughts and feelings elicited by game play, draw analogies between various contents of game play and their own real-life experiences:
   How are the refusal skills rehearsed in the game similar or dissimilar to refusal skills in real life?
   How can refusal vocalizations be utilized in real life? How does it feel to be assertive about drug refusal?
   What if refusal statements and actions make you feel “stupid” or “lame” or rejected by peers?
   What can you do in treatment when discussion or images of drugs make you excited with positive nostalgia, or even provoke cravings? Or in real-life? How can you use urge-surfing, deliberate unmasking, asking for help, and other techniques as an antidote to craving?
   How is fighting off an onslaught of virtual physical drug representations similar or dissimilar to fighting off drugs in real life?
   How are scores earned in a recovery game similar to measures of recovery in real life?
   What are the ways that “health” in real life can be increased or decreased in relation to life encounters and environmental interactions?
   How does the way the game lets you gain powers with success and lose powers with failure mimic real-life? Does positivity build more positivity, health build more health and vice versa?
   How does the productive recollection of or recounting of historical “war stories” of previous drug use contrast with current recovery efforts, redirecting the individual or group away from dwelling too much on the historical glorification of drugs and drug culture?
Using game play as an opportunity for empowerment and promoting self-efficacy—
   encouraging successful game play effort, and discussing as a model of real-life determination in pursuit of a healthy goal.
   overcoming discouragement at unsuccessful play, and discussing as a model of real-life response and determination despite adversity.

Results of treatments via the present invention are envisioned to be positive for the players, while providing a fun and entertaining treatment option. The development of the games of the present invention is based on social cognitive theory within the framework of a bio-behavioral addiction model. Game play is preferably aimed at improving self-efficacy, promoting negative attitudes to drug use, increasing perceived social support from the treatment facility, and providing refusal skills training for the players. Based on the bio-behavioral model and social cognitive theory, game play via the present invention is envisioned to impact opiate recovery in teens through a variety of pathways. It is expected that the games of the present invention will improve recovery by altering established predictors of quitting set forth by social cognitive theory. Additionally, use of the games of the present invention is likely to affect recovery by increasing the use of additional treatment services (e.g. promoting attendance at sessions, and thereby increase contact time with a beneficial environment and counselors.

Examples of the theory-driven mechanisms of the therapeutic effect of the games of the present invention include improvements to the players in terms of:

### Negative Attitudes to Drug Use

Gameplay by players, through ritualized battling and destruction of drug-associated icons, reinforces the sense of drugs as “the enemy” and the adolescent's identity as taking a crystallized stance in opposition to drugs.

### Social Support

It is envisioned that fun gameplay in the treatment setting will make treatment more engaging, and increase the sense of social support provided by the treatment program in which the players are enrolled.
The fun gameplay provided by the present invention increases social support by reinforcing the use of pro-social recreational alternatives to drug use.
Sharing the fun and engaging gameplay of the present invention with other peers in treatment, especially in multi-player gameplay, promotes a sense of common therapeutic goals, prosocial connection to peers, and recovery-oriented social support

### Self-Efficacy

Successful destruction of drug associated icons, reinforced by the inherent and very compelling reward schemes built into video games (points, unlocking new levels, competition, etc.), promotes self-efficacy in the adolescents' sense of success in combating drugs in real life
The virtual transformation of fighting drugs, normally a very complex task in real life, fraught with ambivalence, into a simpler non-ambivalent task in fantasy, will generalize, and promote self-efficacy by helping to tip the decisional balance of the players, translated back from fantasy into real life
The fantasy gameplay helps imbue the struggle to achieve recovery with an aura of heroism, promoting self-efficacy by reinforcing the role of the adolescent as the “Recovery Warrior.”

### Refusal Skills

Certain features of gameplay are configured to simulate critical components of refusal skills (conscious decision stance towards refusal, automatic unconscious decision stance towards refusal, vocalization of refusal via voice control, etc.), and that learning and rehearsal of those components through repetition in the game strengthens refusal skills in real life.

### Treatment and Counselor Alliance

The counselor's role in providing access to fun gameplay translates to an increase in the overall alliance with the counselor/player and treatment.

It should be noted that the preferred title for the games of the present invention is ‘Recovery Warrior,’ however this title is subject to change in alternative embodiments of the present invention.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A gamified addiction therapy method comprising:
connecting a computer equipped with a digital display to a body interface device;
executing a custom game software application on the computer, launching a game-selection screen;
the computer displaying on the digital display a list of games designed to accompany addiction recovery treatment;
wherein the list of games contains the following games: ‘Recovery Racer,’ ‘Recovery Climber,’ ‘Recovery Runner,’ and ‘Recovery Ninja’;
a patient selecting a game from the list of games;
the computer displaying a title splash screen for the game;
the patient beginning the game;
the patient selecting an avatar bearing a resemblance to the patient;
the game presenting, via the digital display, at least one drug-related obstacle;
the game presenting, via the digital display, at least one ‘good item;’
the game presenting, via the digital display, a health meter representing the health of the patient;
the patient manipulating the movement of the avatar within the game via the body interface device;
the patient manipulating the avatar such that a drug-related obstacle strikes the avatar;
wherein said the patient manipulating the avatar such that a drug-related obstacle strikes the avatar causes the health meter to decrease;
the patient manipulating the avatar such that a ‘good item’ contacts the avatar;
wherein the ‘good item’ is at least one of the following: a graphical representation of a diploma, a graphical representation of a child, a graphical representation of a job, and a graphical representation of an engagement ring;
wherein the ‘good item’ displayed to the patient is user-defined; and
wherein collection of a specified amount of ‘good items’ enables the patient to progress to subsequent stages of the selected game.

2. The system of claim 1, further comprising:
interfacing a microphone to the computer;
the patient stating voice commands to the avatar via the microphone conveying drug refusal phrases, reinforcing the refusal language required for use in the real world; and
the avatar refusing drugs on the digital display per the voice commands of the patient.

3. The system of claim 2, further comprising:
the health meter of the avatar of the patient reaching zero; and
the game ending, resulting in the digital display reverting to the splash screen for the game.

4. The method of claim 1, further comprising:
the patient swiping his/her hands, representative of swatting away drugs, to avoid drug-based obstacles displayed on the digital display, shown as approaching the avatar;
the body input device capturing the movement of the patient swiping his/her hands, conveying the action to the avatar; and
the swiping motion of the hands of the patient reinforcing the concept of ‘pushing drugs away’ in the real world.

5. The method of claim 1, further comprising:
the patient swiping his/her hands to collect ‘good items;’
the patient remaining leaning to avoid drug-based obstacles; and
the body input device capturing the movement of the patient swiping his/her hands, conveying the action to the avatar.

6. The method of claim 1, further comprising:
the patient customizing drugs referenced by the drug-based obstacles; and
wherein the drugs referenced include at least one of the following: pills, alcohol, tobacco, injection herion, marijuana, depressants, stimulants, MDMA, and drug paraphernalia.

7. A video game-based recovery/treatment system to assist patients in recovery comprising:
a computer, said computer in communication with a body interface device, a digital display, and at least one camera;
a gamified therapy program, said gamified therapy program running on said computer;
games, said games displayed to the patient via said digital display;
onscreen drugs, said onscreen drugs configured to represent negative aspects to said games;
an avatar, said avatar displayed within said games;
wherein said avatar represents the patient;
wherein movement of said avatar is manipulated by movement of the patient captured via said at least one camera and said body input device;
‘good items,’ said ‘good items’ displayed to the patient on said digital display;
wherein said ‘good items’ are digital representations of goals of the patient; and
wherein said ‘good items’ include at least one of the following: a graphical representation of a diploma, a graphical representation of a child, a graphical representation of a job, and a graphical representation of an engagement ring.
